(19) United States
(12) Patent Application Publication
(10) Pub. No.: US 2014/0023241 A1
(43) Pub. Date: Jan. 23, 2014

(54) DICTIONARY REGISTRATION APPARATUS AND METHOD FOR ADDING FEATURE AMOUNT DATA TO RECOGNITION DICTIONARY

(71) Applicant: TOSHIBA TEC KABUSHIKI KAISHA, Shinagawa-ku (JP)

(72) Inventors: Hiroshi Sugasawa, Miyagi-ken (JP); Hidehiro Naito, Shizuoka-ken (JP)

(21) Appl. No.: 13/939,425

(22) Filed: Jul. 11, 2013

(30) Foreign Application Priority Data
Jul. 23, 2012 (JP) 2012-162852

(51) Int. Cl. G06K 9/00

(52) U.S. Cl. CPC G06K 9/00624
USPC 382/110

(57) ABSTRACT

A dictionary registration apparatus compares the appearance feature amount of a commodity extracted from a captured image with the feature amount data of a recognition dictionary file to extract a candidate of the commodity contained in the image. If a plurality of commodities is extracted, the selection input of the commodity contained in the image from the plurality of commodity candidates is received. If the selection input of one commodity is received, the declaration input indicating whether or not supplement to the feature amount data stored in the recognition dictionary file for the selected commodity is executed is received. If the declaration input indicating the execution of supplement is received, the extracted appearance feature amount data is added to the recognition dictionary file as a feature amount data for the commodity the selection input of which is received.

### CROSS-REFERENCE TO RELATED APPLICATION

This application is based upon and claims the benefit of priority from Japanese Patent Application No. 2012-162852, filed Jul. 23, 2012, the entire contents of which are incorporated herein by reference.

### FIELD

Embodiments described herein relate to a dictionary registration apparatus for recognizing a commodity from an image captured by an image capturing module and a method for adding a feature amount data to a recognition dictionary used in the dictionary registration apparatus.

### BACKGROUND

There is a technology in which the feature amount of a commodity (object) is extracted from the image data of the commodity captured by an image capturing section and a similarity degree is calculated by comparing the extracted feature amount with the feature amount data registered in the recognition dictionary to recognize the category of the commodity according to the calculated similarity degree. Such a technology for recognizing the commodity contained in the image is called as a general object recognition. As to the technology of the general object recognition, various recognition technologies are described in the following document.

Keiji Yanai “Present situation and future of general object recognition”, Journal of Information Processing Society, Vol. 48, No. SIG16 [Search on Heisei 22 August 10], Internet <URL: http://mm.cs.uec.ac.jp/IPSJ-TCVIM-Yanai pdf>

In addition, the technology carrying out the general object recognition by performing an area-division on the image for each object is described in the following document.

Jamie Shotton etc, “Semantic Texton Forests for Image Categorization and Segmentation”, [Search on Heisei 22 August 10], Internet <URL:http://citeseerx.ist.psu.edu/viewdoc/download?doi=10.1.1.145.3036&rep=repl&type=pdf>

In recent years, for example, there is a proposal in which the general object recognition technology is applied to a recognition apparatus for recognizing a commodity purchased by a customer, especially, a commodity without a barcode, such as, vegetables, fruits and the like in a checkout system (POS system) of a retail store. In this case, the feature amount data for representing appearance information such as the appearance shape, color (hue), pattern, and concave-convex (surface roughness) of a commodity in the form of parameters is stored in the recognition dictionary. The commodity recognition apparatus extracts the feature amount in the appearance of a commodity from the image data of the commodity captured by the capturing module and compares the feature amount with the feature amount data of each commodity registered in the recognition dictionary to output a registration commodity similar in the feature amount to the commodity that is recognized as a candidate of the recognized commodity.

### BRIEF DESCRIPTION OF THE DRAWINGS

FIG. 1 is an external view illustrating a store checkout system;

FIG. 2 is a block diagram illustrating hardware configurations of a scanner unit and a POS terminal;

FIG. 3 is a schematic view illustrating structure of a dictionary data stored in a recognition dictionary file;

FIG. 4 is a block diagram illustrating function of a dictionary registration apparatus;

FIG. 5 is a schematic view illustrating a memory area required to realize the recognition dictionary supplement function;

FIG. 6 is a flowchart illustrating the main portion of the information processing procedure executed by the CPU of the dictionary registration apparatus according to a commodity recognition method and a recognition dictionary supplement method;

FIG. 7 is a flowchart illustrating the specific procedure of the recognition processing shown in ACT ST5 of FIG. 6;

FIG. 8 is a diagram of an example of a selection screen for a registered commodity; and

FIG. 9 is a diagram of an example of a selection screen on which execution of supplement is selected.

### DETAILED DESCRIPTION

In accordance with one embodiment, a dictionary registration apparatus includes an extraction module, a candidate extraction module, a selection receiving module, a supplement reception module and a supplement module.

The extraction module is configured to extract feature amount of a commodity contained in image captured. The candidate extraction module is configured to compare the feature amount data extracted by the extraction module with the feature amount data stored in a recognition dictionary file in which feature amount data of commodities are stored to extract the candidate of the commodity contained in the image. The selection receiving module is configured to receive the selection of commodity contained in the image from a plurality of commodity candidates if the plurality of commodity candidates are extracted by the candidate extraction module. The supplement reception module is configured to, if the selection input of one commodity from the plurality of commodity candidates is received by the selection receiving module, receive the supplement to the feature amount data stored in the recognition dictionary file for the selected commodity. The supplement module is configured to, if the input of executing the supplement is received by the supplement reception module, add the feature amount data extracted by the extraction module to the recognition dictionary file as a feature amount data of the commodity of which the selection is received by the selection receiving module.

Embodiments of the dictionary registration apparatus are described with reference to the accompanying drawings. In the embodiment, a scanner unit 1 and a POS (Point Of Sales) terminal 2 constituting a store checkout system of a retail store which deals in fresh food and the like have a function of a dictionary registration apparatus. The dictionary registration apparatus can serve as a commodity recognition apparatus for recognizing a commodity, as well. In the following description, the dictionary registration apparatus is described as a commodity recognition apparatus.

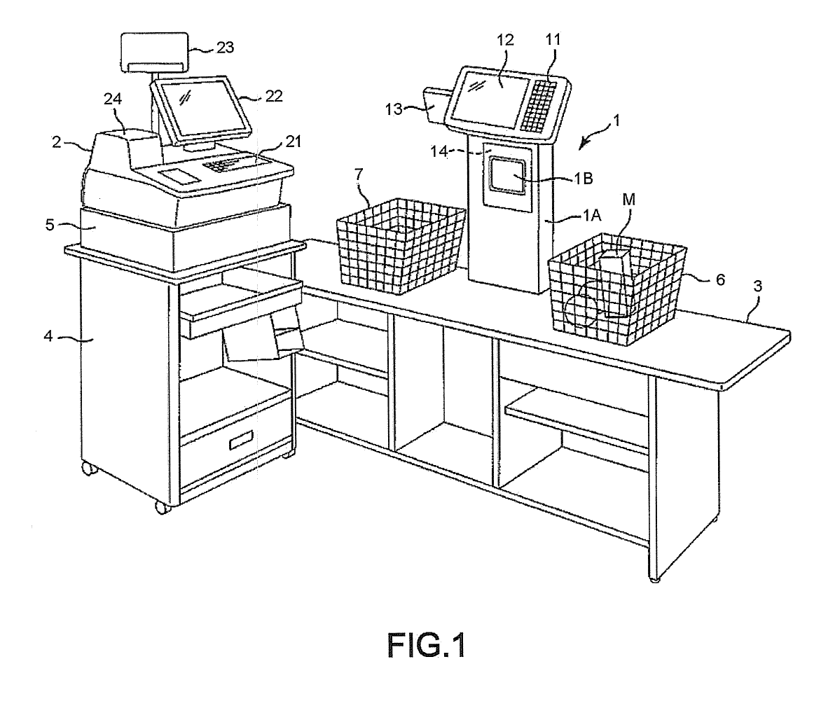

FIG. 1 is an external view of a store checkout system. The system includes a scanner unit 1 as a registration module for registering a commodity purchased by a customer and a POS (Point Of Sales) terminal 2 as a settlement section for processing the payment by the customer. The scanner unit 1 is mounted on a checkout counter 3. The POS terminal 2 is arranged on a register table 4 via a drawer 5. The scanner unit 1 and the POS terminal are electrically connected with each other through a communication cable (not shown).

The scanner unit 1 comprises a keyboard 11, a touch panel 12 and a display for customer 13. Those display or operation devices (keyboard 11, touch panel 12, and display for customer 13) are attached to a thin rectangular housing 1A constituting a main body of the scanner unit 1.

An image capturing section 14 is installed in the housing 1A as an image capturing module. In addition, a reading window 1B is formed in a rectangular shape at the front side of the housing 1A. The image capturing section 14 comprises a CCD (Charge Coupled Device) image capturing element as an area image sensor, a drive circuit thereof, and an image capturing lens for focusing an image of the image capturing area on the CCD image capturing element. The image capturing area refers to an area of frame image which is focused on the area of the CCD image capturing element through the image capturing lens from the reading window 1B. The image capturing section 14 outputs the image focused on the image capturing area of the CCD image capturing element through the lens.

The POS terminal 2 comprises a keyboard 21, a display for operator 22, a display for customer 23 and a receipt printer 24 as devices required for settlement.

The checkout counter 3 is formed in an elongated-shape along a customer passage at the rear side of the checkout counter. The register table 4 is arranged at substantially right angle to the checkout counter 3 at the end of the checkout counter 3 at the downstream side in the movement direction of a customer moving along the checkout counter 3. The checkout counter 3 and the register table 4 define a space for a store clerk in charge of settlement, i.e., so called casher.

At the center of the checkout counter 3, the housing lA of the scanner unit 1 is vertically arranged such that the keyboard 11, the touch panel 12 and the reading window 1B are directed to the space for a store clerk (cashier). The display for customer 13 of the scanner unit 1 is arranged on the housing 1A, facing to the customer passage.

A first upper surface portion of the checkout counter 3 at the upstream side of the scanner unit 1 in the customer movement direction serves as a space for placing a shopping basket 6 in which an unregistered commodity M purchased by a customer is held. On the other side, a second upper surface portion at the downstream side of the scanner unit 1 serves as an another space for placing a shopping basket 7 in which a commodity M registered by the scanner unit 1 is held.

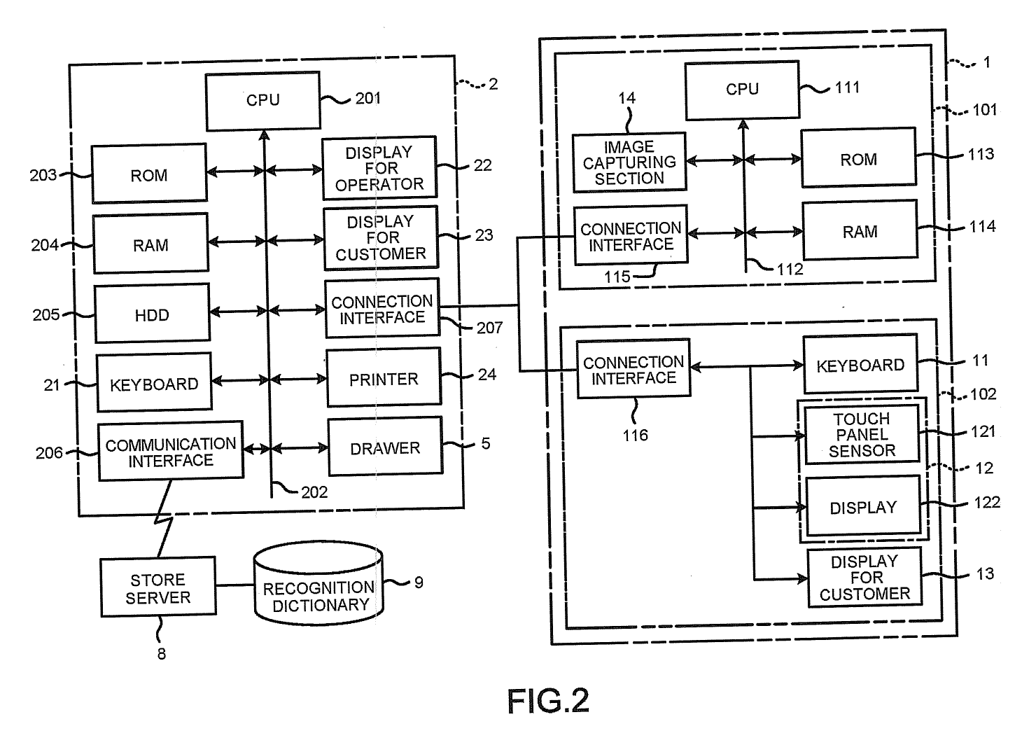

FIG. 2 is a block diagram illustrating the hardware configurations of the scanner unit 1 and the POS terminal 2. The scanner unit 1 comprises a scanner section 101 and an operation-display section 102. The scanner section 101 carries a CPU (Central Processing Unit) 111 as a main body of control section. The CPU 111 is connected with a ROM (Read Only Memory) 113 and a RAM (Random Access Memory) 114 via a bus line 112 such as an address bus, a data bus and the like. A program executed by the CPU 111 is stored in the ROM 113.

The image capturing section 14 is connected with the bus line 112 via an input-output circuit (not shown). The keyboard 11, the touch panel 12, and the display for customer 13 are connected with the bus line 112 via a connection interface 115 and a connection interface 116. The touch panel 12, for example, comprises a panel display section 121 utilizing a liquid crystal display and a touch panel sensor 122 overlaid on the screen of display section.

The connection interface 116 and the keyboard 11, the touch panel 12 and the display for customer 13 constitute the operation-display section 102. Each section constituting the operation-display section 102 is controlled not only by the CPU 111 of the scanner section 101 but also by a CPU 201 of the POS terminal 2 described below.

The POS terminal 2 also carries a CPU 201 as a main body of control section. The CPU 201 is connected with a ROM 203, a RAM 204, a HDD (Hard Disk Drive) unit 205, a communication interface 206 and a connection interface 207 via the bus line 202. In addition, the keyboard 21, display for operator 22, display for customer 23, printer 24 and drawer 5 are respectively connected with the bus line 202 via the input-output circuit (not shown).

The communication interface 206 is connected with a store server 8 serving as the center of a store via a network such as a LAN (Local Area Network) and the like. Through this connection, the POS terminal 2 can perform a transmission/reception of data with the store server 8. Thus, the POS terminal 2 accesses the recognition dictionary file 9 and the commodity data file (not shown) and the like stored in the store server 8, to read the data record stored in each file, or update (add, change, delete) the data record.

The connection interface 207 is connected with the two connection interfaces 115 and 116 of the scanner unit 1 via a communication cable. Through the connection, the POS terminal 2 receives information read by the scanner section 101 of the scanner unit 1. In addition, the POS terminal 2 performs a transmission/reception of data signals with the keyboard 11, the touch panel 12 and the display for customer 13 which constitute the operation-display section 102 of the scanner unit 1.

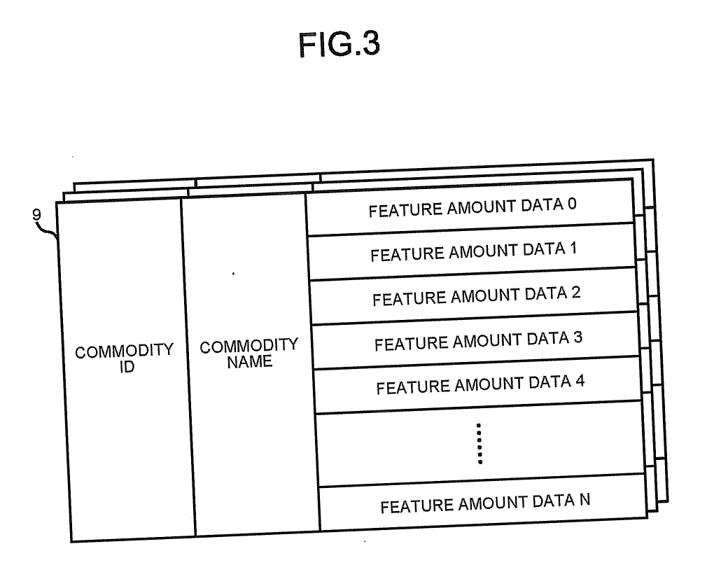

FIG. 3 is a schematic view illustrating the structure of dictionary data stored in the recognition dictionary file 9. As shown in FIG. 3, a plurality of feature amount data for each commodity subject to the recognition are stored in the recognition dictionary file 9 in association with the commodity ID for identifying the commodity and the commodity name thereof. The feature amount data represent in the form of parameters the appearance feature amount, namely, appearance information (an appearance of shape, a color, a pattern, a concave-convex and the like) of the commodity that is identified with the corresponding commodity ID. A plurality of feature amount data (0 to N) of the commodity observed from different directions are respectively stored for one commodity. However, the number of the feature amount data of a commodity (N+1) is not fixed. For example, the number of the feature amount data (N+1) is different from one another according to various kinds of commodities.

A commodity ID is uniquely assigned to each commodity sold in the store. The commodity information such as the commodity name, unit price, pre-set image and the like is stored in the commodity data file in association with the commodity ID of each commodity.

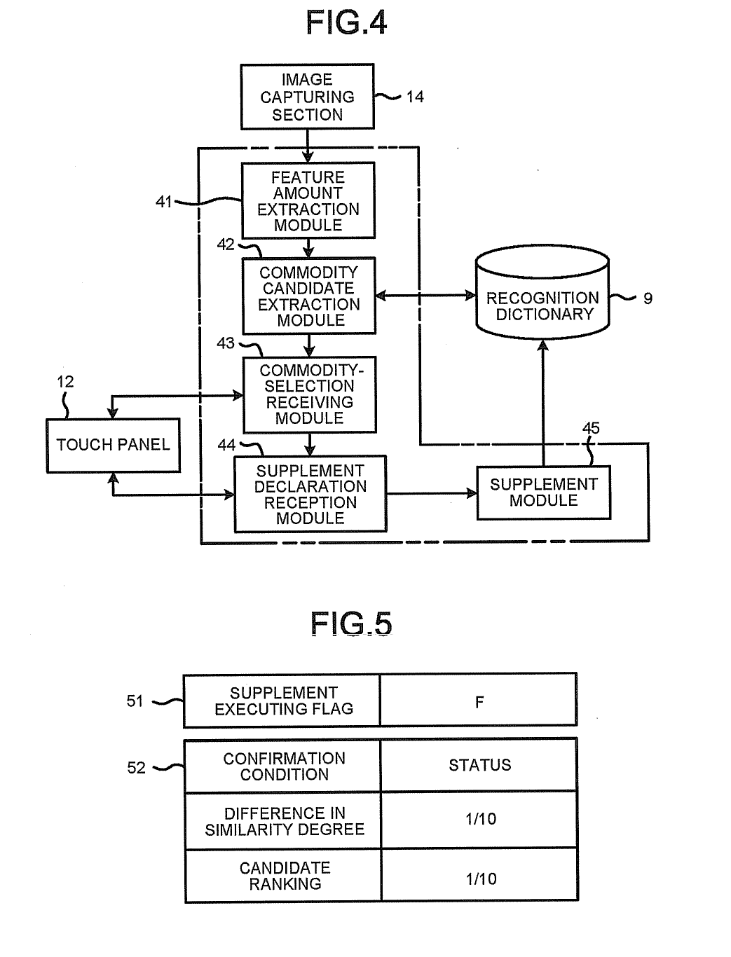

FIG. 4 is a block diagram illustrating functions of a commodity recognition apparatus constituted with the scanner unit 1 and the POS terminal 2. The functions include a feature amount extraction module 41, a commodity candidate extraction module 42, a commodity-selection receiving module 43, a supplement declaration reception module 44 and a supplement module 45.

The feature amount extraction module 41 extracts the feature amount in the appearance (appearance feature amount) such as a shape, a surface color, a pattern, a concave-convex and the like of a commodity contained in the image captured by the image capturing section 14. The commodity candidate extraction module 42 compares successively the appearance feature amount data extracted by the feature amount extraction module 41 with the feature amount data of each commodity stored in the recognition dictionary file 9 to calculate the similarity degree of data for each commodity.

The calculation method of similarity degree is not particularly limited and, for example, the similarity degree may be calculated using a method of Hamming distance in which the number of different characters located in corresponding positions in two feature amount data each having equal number of characters are counted.

The commodity candidate extraction module 42 extracts the commodity with similarity degree higher than a reference as candidate of the commodity contained in the image. For example, the similarity degree may be a degree of coincidence (rate of coincidence) or a correlation value showing the degree of correlation. That is, the similarity degree is a value obtained according to the feature amount of the image captured by the image capturing section 14 and the feature amount stored in the recognition dictionary file 9.

If a plurality of commodities are recognized by the commodity candidate extraction module 42 as a candidate of commodity contained in the image, the commodity-selection receiving module 43 receives the selection-input of the commodity contained in the image from the plurality of commodities. If the commodity-selection receiving module 43 receives the selection-input of any one of the plurality of commodities, the supplement declaration reception module 44 receives the declaration input indicating whether or not the supplement to the feature amount data stored in the reorganization dictionary file 9 is executed for the selected commodity. If the supplement declaration receiving module 44 receives the declaration input indicating that supplement is executed, the supplement module 45 adds the appearance feature amount data extracted by the feature amount extraction module 41 to the recognition dictionary file 9 as a feature amount data for the commodity that the selection is received by the commodity-selection receiving module 43. In other words, the commodity recognition apparatus (scanner unit 1 and POS terminal 2) has a recognition dictionary supplement function in which the feature amount data is added to the recognition dictionary file 9 according to the result of the recognition processing.

FIG. 5 is a schematic view illustrating a memory area necessary for realizing the recognition dictionary supplement function. A memory area 51 is a storage area in which a supplement executing flag F is stored. The commodity recognition apparatus makes the recognition dictionary supplement function effective when the supplement executing flag F is “ON” and makes the recognition dictionary supplement function ineffective when the supplement executing flag F is “OFF”. The memory area 52 is a table area in which the confirmation condition indicating whether or not the supplement to the recognition dictionary file 9 is executed according to the status (1 or 0) is set. The confirmation condition includes a “difference in similarity degree” and a “candidate ranking”. When the status is “1”, the corresponding confirmation condition becomes effective. When the supplement executing flag F is “ON”, the status of either one of the confirmation conditions, i.e., “difference in similarity degree” and “candidate ranking” becomes “1” is effective.

The supplement declaration reception module 44 receives the declaration input indicating whether or not supplement is executed when the similarity degree between the feature amount data stored in the recognition dictionary file 9 of the commodity that the selection is received by the commodity-selection receiving module 43 and the appearance feature amount data extracted by the feature amount extraction module 41 is lower than the similarity degree between the feature amount data of other commodities, stored in the recognition dictionary file 9, which are extracted as a candidate by the commodity candidate extraction module 42 and the appearance feature amount data extracted by the feature amount extraction module 41.

Specifically, if the difference between the similarity degree of the commodity the selection of which is received and the highest similarity degree in the similarity degrees of other commodities recognized as a candidate is greater than a specified value, the declaration input indicating whether or not the supplement is executed is received. Or, if the similarity degree of the commodity the selection of which is received is lower than the specified ranking excluding the highest ranking in descending order in all of the similarity degrees of the commodities recognized as a candidate, the declaration input indicating whether or not the supplement is executed is received.

The former supplement declaration reception module is executed when the status of the confirmation condition, i.e., “difference in similarity degree” is “1”, and the latter supplement declaration reception module is executed when the status of the confirmation condition, i.e., “candidate ranking”, is “1”.

The memory areas 51 and 52 are formed in the RAM 204 of the POS terminal 2. The memory areas 51 and 52 may also be formed in the RAM 114 of the scanner unit 1. An operation in which whether or not the supplement executing flag F in the memory area 51 is turned ON is executed automatically or manually in the setting job of the POS terminal 2. Similarly, the setting operation in which which one of the statuses in the confirmation condition in the memory area 51 is to be “1” is also executed automatically or manually in the setting job of the POS terminal 2.

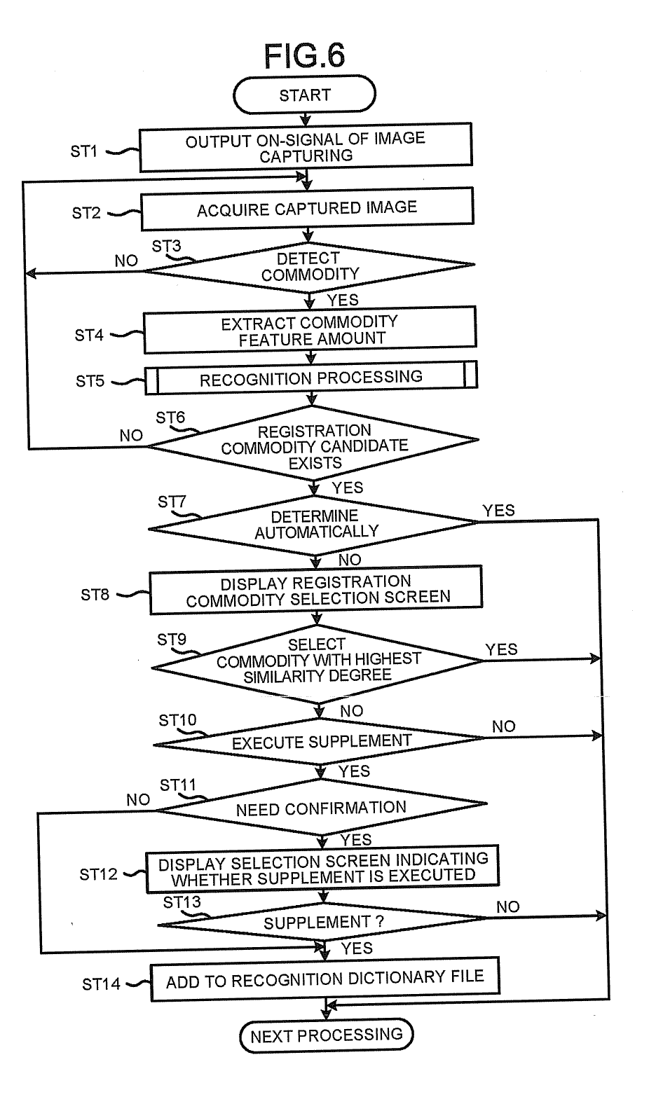

FIG. 6 is a flowchart illustrating the main portion of the information processing procedure executed by the CPU (CPU 111, CPU 201) of the commodity recognition apparatus (scanner unit 1 and POS terminal 2) according to a commodity recognition program or method and a recognition dictionary supplement program or method. In FIG. 6, the processing from ACT ST1 to ACT ST7 are executed according to the commodity recognition program or method, and the processing from ACT ST8 to ACT ST14 are executed according to the recognition dictionary supplement program or method.

The commodity recognition program or method and the recognition dictionary supplement program or method may be an independent program, or a single program. The commodity recognition program and the recognition dictionary supplement program are stored in the ROM 203 of the POS terminal 2. It is also possible to store at least a part of the programs in the ROM 113 of the scanner unit 1.

When the processing of FIG. 6 is started, the CPU (CPU 111 or CPU 201, hereafter the same) outputs an ON-signal of image capturing to the image capturing section 14 (ACT ST1). For example, the CPU 201 instructs the execution of image capturing to the CPU 111, and the CPU 111 outputs an ON-signal of image capturing to the image capturing section 14 upon receiving the instruction. The image capturing section 14 starts an image capturing to the image capturing area according to the ON-signal. of image capturing. The frame images of the image capturing area captured by the image capturing section 14 are sequentially stored in the RAM 114.

The CPU acquires the frame image data stored in the RAM 114 (ACT ST2). Then, the CPU confirms whether or not a commodity is detected from the frame image (ACT ST3). Specifically, the CPU extracts contour lines and the like from the binary image of the frame image. And then, the CPU tries to extract the contour of an object imaged in the frame image. If the contour of an object is extracted, the CPU takes the image within the contour as a commodity.

If a commodity is not detected from the frame image (NO in ACT ST3), the CPU acquires the next frame image from the RAM 114 (ACT ST2). And then, the CPU confirms whether or not a commodity is detected from the frame image (ACT ST3).

If a commodity is detected from the frame image (YES in ACT ST3), the CPU extracts the feature amount in the appearance (appearance feature amount) such as the shape, surface color (hue), pattern, concave-convex (surface roughness) of the commodity from the image in the contour (ACT ST4: feature amount extraction module 41). The extracted appearance feature amount data are temporarily stored in the work area of the RAM 204.

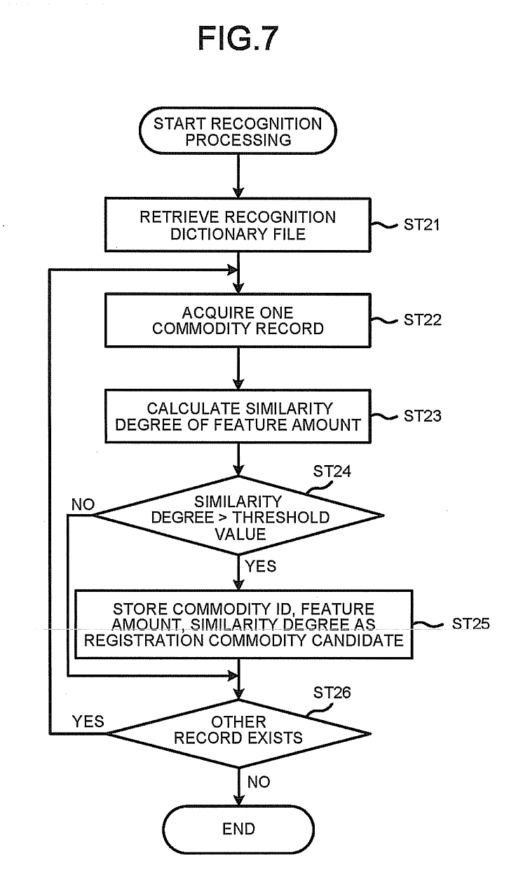

When the extraction of feature amount is finished, the CPU executes the recognition processing specifically shown in FIG. 7 (ACT ST5: commodity candidate extraction module 42). First, the CPU retrieves the recognition dictionary file 9 in the store server 8 (ACT ST21). Then the CPU reads the data record (commodity ID, commodity name, and a plurality of feature amount data) of one commodity from the recognition dictionary file 9 (ACT ST22).

When the data record is read, the CPU calculates the similarity degree indicating how much similar is the appearance feature amount data extracted in the processing of ACT ST4 to the feature amount data of the record (ACT ST23). The greater the similarity value is, the higher the similarity rate (degree) is. In the present embodiment, the similarity degree of the feature amount data is calculated for each commodity as the upper limit of the similarity degree is “100”.

The CPU confirms whether or not the similarity degree is higher than a specified reference threshold value (ACT ST24) The reference threshold value is a lower limit for the similarity degree of the commodity which should be retained as a candidate of registration commodity. As described above, if the upper limit value of similarity degree is set to “100”, the reference threshold value, for example, can be set to “20” which is one fifth of the upper limit value thereof. When the similarity degree is higher than the reference threshold value (YES in ACT ST24), the CPU stores the commodity ID and the commodity name in the data record, the appearance feature amount data extracted in the processing of ACT ST4, and the similarity degree calculated in the processing of ACT ST23 in the specified area of the RAM 204 as a candidate of registration commodity (ACT ST25). On the contrary, if the similarity degree is lower than the reference threshold value (NO in ACT ST24), the CPU does not execute the processing of ACT ST25.

After that, the CPU confirms whether or not there is an unprocessed data record in the recognition dictionary file 9 (ACT ST26). If there is an unprocessed data record (YES in ACT ST26), the CPU returns to the processing of ACT ST22. Namely, the CPU reads the unprocessed data record from the recognition dictionary file 9, and executes the processing of ACTs ST23-ST26.

When the processing of ACTs ST23 to ST26 is executed to all the data records of commodities stored in the recognition dictionary file 9, the recognition processing is ended (NO in ACT ST26). If the recognition processing is ended, the CPU confirms whether or not there is a candidate of registration commodity (ACT ST6).

There is no candidate of registration commodity if no commodity data (commodity code, commodity name, appearance feature amount, and similarity degree) is stored in the specified area of the RAM 204 as a candidate of registration commodity. In this condition (NO in ACT ST6), the CPU returns to the processing of ACT ST2. Namely, the CPU acquires the next frame image data from the RAM 114. Then, the CPU executes the processing of ACTs ST3 to ST6 to the image data.

On the other hand, there is a candidate of registration commodity if at least one commodity data (commodity code, commodity name, appearance feature amount, and similarity degree) is stored in the specified area of the RAM 204 as a candidate of registration commodity. In this condition (YES in ACT ST6), the CPU confirms whether or not the registration commodity can be set automatically (ACT ST7). Specifically, the CPU confirms whether or not there is only one data of which the similarity degree is higher than the specified determination threshold value in the commodity data representing a candidate of registration commodity. The determination threshold value is much greater than the reference threshold value, and in a case that the upper limit value of similarity degree is set to “100” as stated above, the determination threshold value is set to be a value greater than half of the upper limit value, for example, “60”.

If there is only one commodity the similarity degree of which is higher than the determination threshold value in the candidates of registration commodity, the commodity is automatically determined to be a registration commodity. In addition, if there is no commodity or more than two commodities the similarity degree of which is or are higher than the determination threshold value, the registration commodity is not determined. If the registration commodity is determined (YES in ACT ST7), the CPU skips the processing following to ACT ST8, namely the processing routine of the recognition dictionary supplement program, and proceeds to the next processing, namely the registration processing routine of the commodity automatically determined.

On the contrary, if the registration commodity is not determined (NO in ACT ST7), the CPU displays the registration commodity selection screen 60 on the touch panel 12 (ACT ST8: commodity-selection receiving module 43).

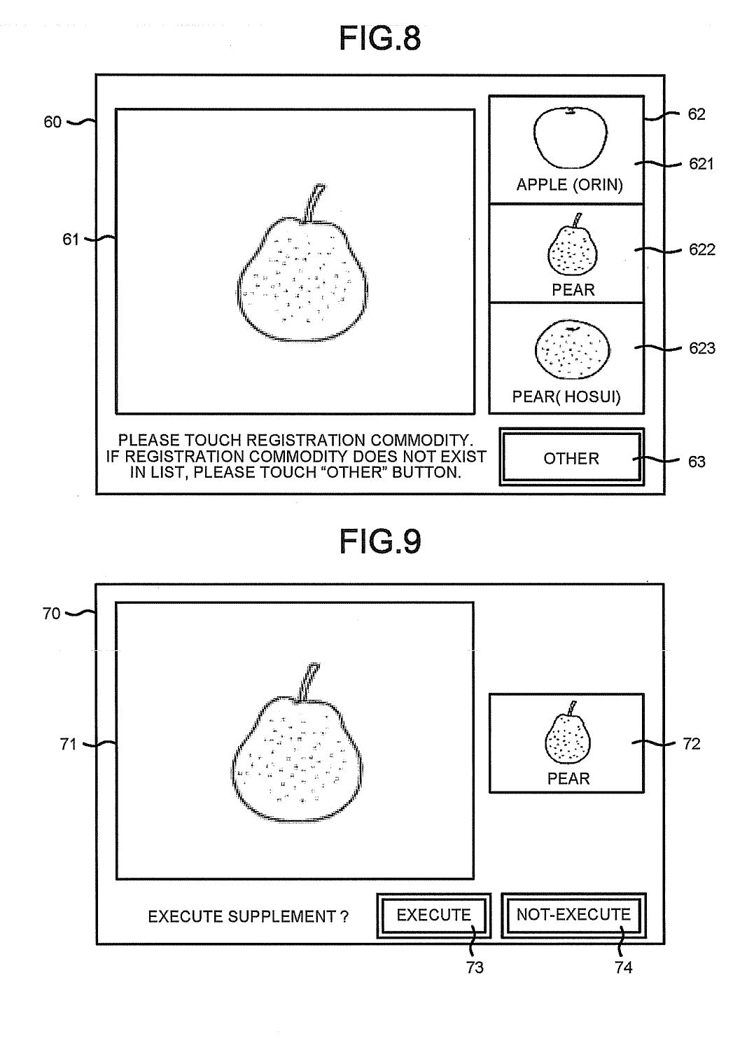

One example of the registration commodity selection screen 60 is shown in FIG. 8. As shown in FIG. 8, the registration commodity selection screen 60 is divided into a captured image display area 61 and a candidate commodity display area 62. In addition, an “Other” button 63 is displayed on the registration commodity selection screen 60. The frame image acquired in the processing of ACT ST2 is displayed in the captured image display area 61. The candidate commodity display area 62 is further divided into three areas 621, 622 and 623 to display on the screen preset images of the commodities that are the candidates of registration commodity in descending order of the similarity degree from the upper part of the screen to the lower part thereof.

In addition, in the initial screen, the preset images of commodities of which the similarity degree is ranked from the first to the third are displayed in the candidate commodity display area 62 (621,622, and 623) from the upper part of the screen in order. In this state, if the “Other” button 63 is touched, the candidate commodity display area 62 is switched to display the preset images of the commodities of which the similarity degree is ranked the forth to the sixth. Hereafter, every time the “Other” button 63 is touched, the area 62 is switched to display the preset images of the commodities of which the similarity degree is ranked at lower-order. In addition, if the “Other” button 63 is touched once, the image of a “Return” button is displayed on the registration commodity selection screen 60. If the “Return” button is touched, the screen of the touch panel 12 returns to the registration commodity selection screen 60 displayed immediately before the “return” button is touched.

A user holding the registration commodity over the reading window 1B looks for a commodity the same as the registration commodity in the candidate commodity display area 62. If a commodity the same as the registration commodity is found, the user touches one of the areas 621, 622 or 623 where the preset image of the commodity is displayed.

The CPU waits for until one of the candidate commodity display areas 62 is touched. If one of the candidate commodity display area 62 is touched, the CPU confirms the order (ranking) of the similarity degree of the commodity of which the preset image is displayed in the area touched (ACT ST9). If the commodity of which the similarity degree is ranked at the first is selected (Yes in ACT ST9), the CPU skips the processing after ACT ST10 and proceeds to the next processing, that is, the registration processing routine of the commodity of which the similarity degree is ranked at the first.

On the contrary, if the commodity of which the similarity degree is ranked at the second or lower than the second is selected (NO in ACT ST9), the CPU checks the supplement executing flag F (ACT ST10). If the supplement executing flag F is “OFF”, the supplement of recognition dictionary is not executed. In this case (NO in ACT ST10), the CPU skips the processing after ACT ST11, and proceeds to the next processing, namely the registration processing routine of the selected commodity.

If the supplement executing flag F is “ON”, the CPU determines whether or not the confirmation for execution of the supplement is required (ACT ST11). Namely, the CPU checks the memory area 52 to acquire the confirmation condition of which the status is “1”. If the confirmation condition is a “difference in similarity degree”, the CPU calculates a difference between the similarity degree of the selected commodity and the highest similarity degree (similarity degree at the first) to confirm whether or not the difference value is greater than the specified threshold value. Then the CPU determines it to be necessary to make a confirmation to a user if the difference value is greater than the specified threshold value or determines it to be unnecessary to make a confirmation to a user if the difference value is lower than the specified threshold value.

On the other hand, if the confirmation condition is a “candidate ranking”, the CPU confirms whether or not the ranking of the similarity degree of the selected commodity is lower than the ranking of the specified threshold value which is below the first (for example, the third). Then the CPU determines it to be necessary to make a confirmation to a user if the ranking of the similarity degree is lower than the ranking of the threshold value or determines it to be unnecessary to make a confirmation to a user if the ranking of similarity is higher than the ranking of threshold value.

If the confirmation is determined to be necessary in ACT ST11 (Yes in ST11), the CPU displays a supplement execution selection screen 70 on the touch panel 12 (ACT ST12: supplement declaration reception module 44).

FIG. 9 is an example of the supplement execution selection screen 70. As shown in FIG. 9, the supplement execution selection screen 70 is divided into a captured image display area 71 and a selected commodity display area 72. In addition, the “Execute” button 73 and “Not-execute” button 74 are also displayed on the supplement execution selection screen 70. In the captured image display area 71, the frame image acquired in the processing of ACT ST2 is displayed. In the selected commodity display area 72, the preset image of the commodity selected on the registration commodity selection screen 60 is displayed. FIG. 9 illustrates the supplement execution selection screen 70 in case in which the commodity “pear” of which the preset image is displayed in the area 622 is selected in the registration commodity selection screen 60 in FIG. 8. The position of the selected commodity display area 72 may be the same as the candidate commodity display area 62 where the preset image of the commodity selected in the registration commodity selection screen 60 as shown in FIG. 9, or may also be different from the candidate commodity display area 62. In case in which it is displayed at the position same as that of the candidate commodity display area 62 where the preset image is displayed, it can be known at a glance that the selection is executed.

A user touches the “Execute” button 73 if the supplement of the feature amount data to the recognition dictionary is executed. On the contrary, the user touches the “Not-execute” button if the supplement is not executed due to the commodity that is erroneously selected, for example.

The CPU waits for until one of the buttons of “Execute” and “Not-execute” is touched. If the “Not-execute” button 74 is touched (NO in ACT ST13), the CPU skips the processing of ACT ST13 and proceeds to the next processing. However, since the selected commodity is the incorrect one, the commodity registration processing routine is not executed.

If the “Execute” button 73 is touched (YES in ACT ST13), or if the confirmation is determined to be unnecessary in the processing of ACT ST11 (NO in ACT ST11), the CPU executes supplement of the feature amount data to the recognition dictionary file 9 (ACT ST14: supplement module 45). Namely, the CPU reads the commodity code and the appearance feature amount data from the commodity data (commodity code, commodity name, appearance feature amount data, and similarity degree) of the selected commodity. Then, the CPU accesses the recognition dictionary file 9 to add the appearance feature amount data to the data record including the commodity code as a new feature amount data. After that, the CPU proceeds to the next processing, namely, the registration processing routine of the selected commodity.

In the store checkout system of the present embodiment, a commodity to be purchased is photographed by the image capturing section 14 when a user holds the commodity to the reading window 1B of the scanner unit 1. Similarity degree of the feature amount is calculated for each commodity according to the appearance feature amount data extracted from the image of the commodity and the feature amount data of each commodity registered in the recognition dictionary file 9. Candidates of the registration commodity are determined in descending order of the similarity degree and the list thereof is displayed on the touch panel 12. Therefore, the user selects a commodity from the candidates of the registration commodity. Thus, in the store checkout system, the sales data of the selected commodity is registered.

If the selected commodity has a highest similarity degree, the feature amount data of the commodity registered in the recognition dictionary file 9 is approximate to the appearance feature amount data of the commodity purchased by the user. Thus, it is unnecessary to add the feature amount data of the commodity purchased to the recognition dictionary file 9. On the contrary, if the similarity degree of the selected commodity is lower than the similarity degree of other unselected commodities, it is necessary to add the feature amount data of the commodity purchased to the recognition dictionary file 9.

In the store checkout system of the present embodiment, if the selected commodity has a highest similarity degree, the supplement of the feature amount data to the recognition dictionary file 9 is not executed. If the selected commodity does not have a highest similarity degree, the supplement of the feature amount data to the recognition dictionary file 9 is executed. However, the supplement of the feature amount data to the recognition dictionary file 9 is not allowed in a condition that the supplement executing flag F is reset to “0”. In this case, the supplement of the feature amount data to the recognition dictionary file 9 is not executed even if the selected commodity does not have a highest similarity degree.

In addition, if the “difference in similarity degree” is set as a confirmation condition, namely, the status corresponding to the confirmation condition, i.e., “difference in similarity degree” is set to “1”, a difference between the similarity degree of selected commodity and the highest similarity degree in commodities recognized as the registration commodity candidate is calculated. Then, it is determined whether or not the difference is greater than the specified threshold value. If the difference is not higher than the threshold value, namely, if the similarity degree of the selected commodity is relatively high, the supplement of the feature amount data to the recognition dictionary file 9 is executed.

On the contrary, if the difference is higher than the threshold value, namely, if the similarity degree of the selected commodity is relatively low, there may be a possibility that the user selects an incorrect commodity. Therefore, the supplement execution selection screen 70 is displayed on the touch panel 14. The user who confirms the supplement execution selection screen 70 touches the “Execute” button 73 if the selected commodity is the correct one, or touches the “Not-execute” button 74 if the selected commodity is the incorrect one. As a result, the supplement of the feature amount data to the recognition dictionary file 9 is executed if the selected commodity is the correct one but the supplement of the feature amount data to the recognition dictionary file 9 is not executed if the selected commodity is the incorrect one.

In addition, if the “candidate ranking” is set as a confirmation condition, namely, the status corresponding to the confirmation condition, i.e., “candidate ranking” is set to “1”, the ranking in descending order of the similarity degree of the selected commodity in the commodities recognized as the registration commodity candidate is checked. Then, it is determined that the similarity degree of the selected commodity is ranked higher or lower the specified threshold value which is below the first. As a result, if the similarity degree of the selected commodity is ranked higher than or equal to the threshold value, namely, if the similarity degree of the selected commodity is relatively high, the supplement of the feature amount data to the recognition dictionary file 9 is executed.

On the contrary, if the similarity degree of the selected commodity is ranked lower than the threshold value, namely, if the similarity degree of the selected commodity is relatively low, there may be a possibility that the user selects an incorrect commodity. Therefore, the supplement execution selection screen 70 is displayed on the touch panel 14. The user who confirms the supplement execution selection screen 70 touches the “Execute” button 73 if the selected commodity is the correct one, or touches the “Not-execute” button 74 if the selected commodity is the incorrect one. As a result, the supplement of the feature amount data to the recognition dictionary file 9 is executed if the selected commodity is the correct one but the supplement of the feature amount data to the recognition dictionary file 9 is not executed if the selected commodity is the incorrect one.

According to the present embodiment, it is possible to efficiently add the feature amount data to the recognition dictionary file with a simple operation.

The invention is not limited to the embodiment described above.

For example, in the embodiment described above, two kinds of the confirmation conditions, i.e., “difference in similarity degree” and “candidate ranking”, are described as the confirmation condition for confirming whether or not the supplement of the feature amount data to the recognition dictionary file 9 is executed. However, either one of the “difference in similarity degree” and the “candidate ranking” may be adopted or, other conditions may also be adopted.

The supplement declaration reception module 44 displays the button images 73 and 74 for the declaration input indicating whether or not supplement is executed on the touch panel 12, and receives the declaration input. However, it is not limited to this. For example, the declaration input indicating whether or not supplement is executed by the input from the specified key of the keyboard 11 may be received. Also, the commodity-selection receiving module 43 is not limited to the input operation on the registration commodity selection screen 60. The point is that a user can select one from a plurality of commodities recognized as a registration commodity candidate.

Further, in the embodiment described above, the scanner unit 1 and the POS terminal 2 have a function of the commodity recognition apparatus. However, either one of the canner unit 1 and the POS terminal 2 may have a function of the commodity recognition apparatus. Or a single apparatus in which the scanner unit 1 is assembled into the POS terminal 2 may have a function of the commodity recognition apparatus.

Further, the commodity recognition apparatus may be constructed with the scanner unit 1, the POS terminal 2 and the server that has a commodity recognition function, i.e., a commodity recognition program, to enable the server to perform recognition processing of commodity candidate. Specifically, the image of a commodity is captured by the scanner, and the commodity image captured by the scanner is sent to the server. The server executes the recognition processing of the commodity candidate by comparing the feature amount of the commodity image with the feature amount of a commodity stored in the recognition dictionary file, and outputs the recognition result to the POS terminal 2.

Further, in the embodiment described above, the control program is pre-recorded in the ROM serving as a program storage section in the apparatus to achieve the functions of the present invention. However, the present invention is not limited to this, the same program may be downloaded to the apparatus from a network. Alternatively, the same program recorded in a recording medium may be also installed in the apparatus. The form of the recording medium is not limited as long as the recording medium can store methods like a CD-ROM and a memory card and is readable by an apparatus. Further, the function realized by an installed or downloaded program can also be achieved through the cooperation with an OS (Operating System) installed in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A dictionary registration apparatus, comprising:
an extraction module configured to extract feature amount of a commodity contained in image captured;
a candidate extraction module configured to compare the feature amount data extracted by the extraction module with the feature amount data stored in a recognition dictionary file in which feature amount data of commodities are stored to extract the candidate of the commodity contained in the image;
a selection receiving module configured to receive the selection of commodity contained in the image from a plurality of commodity candidates if the plurality of commodity candidates are extracted by the candidate extraction module;
a supplement reception module configured to, if the selection input of one commodity from the plurality of commodity candidates is received by the selection receiving module, receive the supplement to the feature amount data stored in the recognition dictionary file for the selected commodity; and
a supplement module configured to, if the input of executing the supplement is received by the supplement reception module, add the feature amount data extracted by the extraction module to the recognition dictionary file as a feature amount data of the commodity of which the selection is received by the selection receiving module.

2. The dictionary registration apparatus according to claim 1, wherein the supplement reception module receives a declaration indicating whether or not the supplement is executed if a similarity degree between the feature amount data of the commodity the selection of which is received by the selection receiving module stored in the recognition dictionary file and the feature amount data extracted by the extraction module is lower than a similarity degree between the feature amount of other commodities extracted as a candidate by the candidate extraction module stored in the recognition dictionary file and the feature amount data extracted by the extraction module.

3. The dictionary registration apparatus according to claim 2, wherein the supplement reception module receives the declaration indicating whether or not the supplement is executed if a difference between the similarity degree of the commodity the selection of which is received by the selection receiving module and the highest similarity degree within the similarity degrees of other commodities extracted as a candidate by the candidate extraction module is greater than a specified value.

4. The dictionary registration apparatus according to claim 2, wherein the supplement reception module receives the declaration input indicating whether or not the supplement is executed if the similarity degree of the commodity the selection of which is received by the selection receiving module is lower than a specified ranking excluding the highest ranking in descending order from all the similarity degrees of the commodities extracted as a candidate by the candidate extraction module.

5. The dictionary registration apparatus according to claim 1, further comprising a touch panel on which the supplement reception module displays a button-image for declaration input indicating whether or not the supplement is executed.

6. A method for adding a feature amount data of commodity to a recognition dictionary file of a dictionary registration apparatus, including:
extracting a feature amount of the commodity contained in an image captured;
comparing the extracted feature amount data with feature amount data of commodities stored in the recognition dictionary file that stores feature amount data of commodities representing surface information of commodities to extract a candidate of the commodity contained in the image;
receiving selection of the commodity contained in the image from a plurality of commodity candidates if the plurality of commodities are extracted as a candidate;
receiving a declaration input of supplement to the feature amount data of the selected commodity candidate stored in the recognition dictionary file if the selection of one of the plurality of commodity candidates is received; and
adding the feature amount data of the commodity contained in the image to the recognition dictionary file as a feature amount data to the commodity the selection of which is received in the recognition dictionary file if the declaration input of supplement is received.
